(19) United States
(12) Patent Application Publication
(10) Pub. No.: US 2023/0325671 A1
(43) Pub. Date: Oct. 12, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: SHUHEI OGAWA, Kanagawa (JP); SHUNTA TATE, Tokyo (JP)

(21) Appl. No.: 18/187,577

(22) Filed: Mar. 21, 2023

(30) Foreign Application Priority Data
Apr. 6, 2022 (JP) 2022-063501

(51) Int. Cl. G06N 3/082

(52) U.S. Cl. CPC G06N 3/082

(57) ABSTRACT

The present disclosure makes it possible to learn a neural network architecture for achieving a sufficient inference accuracy while preventing an increase in the amount of processing. An information processing apparatus configured to learn an architecture for optimizing a structure of a neural network generates a plurality of candidates for an edge of the neural network, inputs learning data to the neural network with weight coefficients set to these candidates for the edge, and obtains an inference result. The information processing apparatus calculates a loss of the neural network based on a specified candidate number which is the number of candidates to be selected from the plurality of candidates and on the inference result, and then updates the weight coefficients for the plurality of candidates based on the loss. The information processing apparatus then selects candidates from the plurality of candidates based on the updated weight coefficients.

### BACKGROUND

### Field of the Disclosure

The present disclosure relates to an information processing technique for learning a neural network architecture.

### Description of the Related Art

In recent years, machine learning techniques, most notably deep learning, ranging from image recognition and speech recognition to machine translation, have achieved rapid advancement. Most of existing neural network architectures are manually generated based on knowledge and experiences by experts. Although a manually generated neural network can achieve a high inference accuracy, it takes a very long time to search for a neural network architecture, and it is difficult for non-experts to search for the relevant architecture. In recent years, research has been actively performed on Neural Architecture Search (NAS), a framework for automatically searching for a neural network architecture. For example, Zoph, et al., “Neural Architecture Search with Reinforcement Learning” discusses searching for an architecture by using the framework of the enhanced learning. More specifically, a structure of Child Network is searched for by using a convolution Recursive Neural Network (Controller RNN), and Child Network most suitable for task is generated. The Controller RNN is then updated based on the policy gradient method by using the accuracy for validation data of the generated Child Network as a return. However, this technique consumes a large amount of calculation resources and takes several days to several weeks to perform the learning, and therefore requires a high cost for the introduction.

As a technique for more efficiently learning a neural network architecture, Liu proposes a technique for enabling differentiation by recognizing the space to be subjected to architecture search as a continuous space, and performing optimization by using the gradient descent method (Liu et al., “DARTS: Differentiable Architecture Search”). Enabling a search by using the gradient descent method in this way makes it possible to optimize a neural network architecture within one to several days. Further, Wu Bichen et al., “FBNet: Hardware-Aware Efficient ConvNet Design via Differentiable Neural Architecture Search”, The IEEE Conference on Computer Vision and Pattern Recognition 2019 proposes an architecture search method in which not only the accuracy but also the latency during network inference is considered at the time of architecture optimization thus providing both accuracy and speed. In the technique discussed in Wu Bichen et al., “FBNet: Hardware-Aware Efficient ConvNet Design via Differentiable Neural Architecture Search”, The IEEE Conference on Computer Vision and Pattern Recognition 2019, the learning progresses so that the weight of a selected edge candidate increases and the weight of a unselected edge candidate decreases in learning the neural network architecture. This is implemented by the Softmax function with temperature, called Gumbel-Softmax. In this case, only one edge candidate is selected. NAS based on the gradient descent method (gradient-based NAS) weights the candidates of a plurality of edges existing between nodes, and selects the edge candidate having the largest weight.

### SUMMARY

The present disclosure is directed to enabling the learning of a neural network architecture that achieves a sufficient inference accuracy while preventing the increase in the amount of processing.

According to an aspect of the present disclosure, an information processing apparatus configured to learn an architecture for optimizing a structure of a neural network includes a candidate generation unit configured to generate a plurality of candidates for an edge of the neural network, an inference unit configured to obtain an inference result by inputting learning data to the neural network with a weight coefficient set to each of the plurality of candidates for the edge, a loss calculation unit configured to calculate a loss of the neural network based on a specified candidate number which is the number of candidates to be selected from the plurality of candidates, and on the inference result, an updating unit configured to update the weight coefficient for each of the plurality of candidates based on the loss, and a selection unit configured to select candidates from the plurality of candidates based on the corresponding updated weight coefficient.

Further features of the present disclosure will become apparent from the following description of exemplary embodiments with reference to the attached drawings.

### BRIEF DESCRIPTION OF THE DRAWINGS

FIG. 1 illustrates an example of a schematic hardware configuration of an information processing apparatus.

FIG. 2 is a functional block diagram illustrating an example of a function configuration of the information processing apparatus.

FIG. 3 is a flowchart illustrating an information processing according to one or more aspects of the present disclosure.

FIG. 4 illustrates an example of a network architecture according to one or more aspects of the present disclosure.

FIG. 5 illustrates a layer configuration according to one or more aspects of the present disclosure.

FIGS. 6A to 6D illustrate examples of four different networks obtained through the learning.

FIGS. 7A to 7C illustrate examples of an input image, a Ground Truth (GT) map, and an inferred map, respectively.

FIGS. 8A to 8C illustrate weight coefficients and weight changes through the learning.

FIG. 9 is a flowchart illustrating an information processing according to one or more aspects of the present disclosure.

FIG. 10 illustrates an example of a network architecture according to one or more aspects of the present disclosure.

FIG. 11 illustrates a layer configuration according to one or more aspects of the present disclosure.

FIGS. 12A and 12B illustrate a template image, a search target image, and a tracking target.

FIG. 13 illustrates pruning.

### DESCRIPTION OF THE EMBODIMENTS

In a technique for automatically searching for a neural network architecture in the above-described gradient-based Neural Architecture Search (NAS) technique, an inference accuracy to a certain extent can be achieved, but the amount of processing in the inference is likely to increase. Thus, it has been demanded to achieve a sufficient inference accuracy while preventing the increase in the amount of processing in the inference.

Exemplary embodiments of the present disclosure will be described below with reference to the accompanying drawings. The following exemplary embodiments do not limit the present disclosure. Not all of the combinations of the features described in the exemplary embodiments are indispensable to the solutions for the present disclosure. The configurations of the following exemplary embodiments may be suitably corrected, modified, and combined as appropriate depending on the specifications and various conditions (operating situations and operating environment) of an apparatus according to the present disclosure. Parts of the following exemplary embodiments may be suitably combined. In the following exemplary embodiments, identical elements are assigned the same reference numerals.

In the present exemplary embodiment, a description will be provided, as an example, of an information processing apparatus that implements functions of a neural network architecture search apparatus that learns an architecture for optimizing the neural network structure. Prior to descriptions of detailed configurations and operations of the information processing apparatus, an overview of the neural network architecture according to the present exemplary embodiment will be described below. In the present exemplary embodiment, a description will be provided, as an example, of learning of the neural network architecture by using the NAS technique based on the gradient descent method (hereinafter, such a Neural Architecture Search is also referred to as gradient-based NAS).

In the gradient-based NAS technique, it is important that the difference in weight between an edge to be selected and an unselected edge increases as the learning progresses. More specifically, with a sufficiently large difference in weight between a candidate for an edge to be selected and a candidate for an unselected edge, the neural network architecture slightly changes after the edge candidate selection. In other words, the influence of the neural network on the inference accuracy is presumed to be small. On the other hand, with a small difference in weight between the candidate for the edge to be selected and the candidate for the unselected edge (in a case of similar weights), the neural network architecture may largely change after the edge candidate selection. As a result, the inference accuracy of the neural network after the learning may possibly decrease.

The present exemplary embodiment selects a plurality of edge candidates, not only one edge candidate, in learning a neural network architecture by using the gradient-based NAS technique. As a technique for selecting a plurality of edges (candidates), selecting edges, for example, in descending order of the weights thereof is considered. In this case, however, with a small difference in weight between each of the plurality of selected edges (candidates) and a deselected edge (candidate), the network architecture may largely change as in the above-described case, possibly resulting in a decrease in inference accuracy.

Thus, even when a plurality of candidates is selected in learning the neural network architecture by using the gradient-based NAS technique, the present exemplary embodiment increases the difference in weight between a selected candidate and an unselected candidate to enable preventing the degradation of the inference accuracy. The neural network operates at higher speeds while saving the larger memory capacity with the smaller number of edges. Therefore, the present exemplary embodiment implements an increased operating speed while saving the memory capacity, selecting the specified number of candidates from all the edges (candidates) to reduce the number of candidates.

A first exemplary embodiment will be described below. In the first exemplary embodiment, a description will be provided of a technique for learning a neural network architecture in an object detection task for detecting the position and/or size of an object from an image.

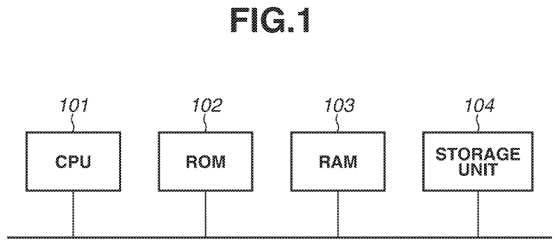

FIG. 1 illustrates an example of a schematic hardware configuration of an information processing apparatus 1 that learns the neural network architecture according to the first exemplary embodiment.

In the configuration in FIG. 1, a central processing unit (CPU) 101 controls the entire apparatus by executing a control program stored in a read only memory (ROM) 102. The ROM 102 also stores an information processing program according to the present exemplary embodiment. The CPU 101 implements the processing for learning the neural network architecture (described below) by executing the information processing program. A random access memory (RAM) 103 temporarily stores various types of data from components. The RAM 103 loads the program stored in the ROM 102, to enable the program to be executed by the CPU 101. A storage unit 104 stores data to be processed by the present exemplary embodiment and stores data to be used in the learning (described below). Examples of media of the storage unit 104 include a hard disk drive (HDD), flash memory, and various types of optical media. The information processing program according to the present exemplary embodiment may also be stored in the storage unit 104.

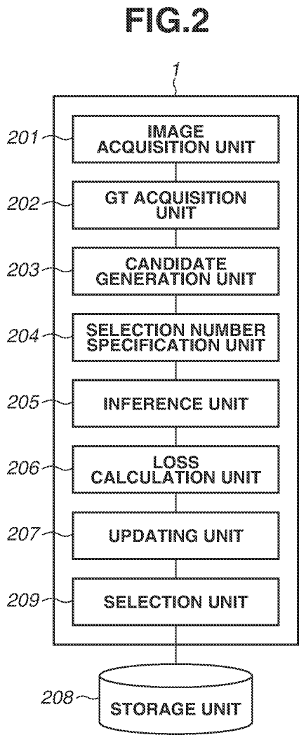

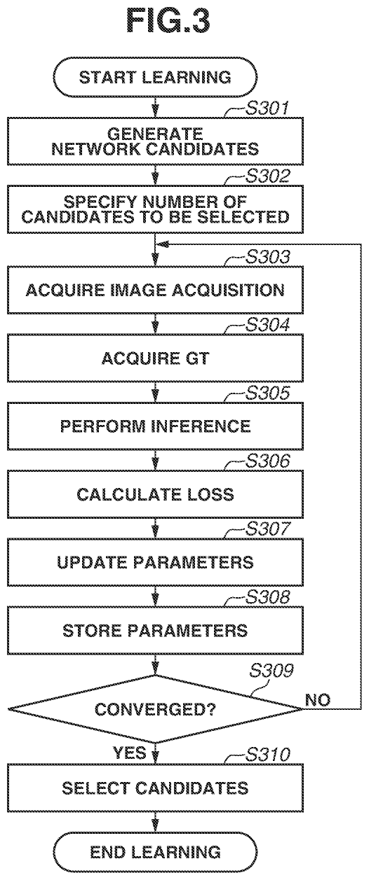

FIG. 2 is a functional block diagram illustrating an example of a functional configuration of the information processing apparatus 1. Each function unit of the information processing apparatus 1 illustrated in FIG. 2 is implemented, for example, by the CPU 101 executing the information processing program according to the present exemplary embodiment. A part or whole of each function unit may be implemented by a hardware component, such as a circuit. FIG. 3 is a flowchart illustrating information processing in the information processing apparatus 1, or learning processing of the neural network architecture, according to the first exemplary embodiment. According to the first exemplary embodiment, the information processing apparatus 1 learns a neural network architecture in an object detection task for detecting an object from an image.

An image acquisition unit 201 acquires an image stored in a storage unit 208. The image includes detection target objects, such as persons and vehicles. Although, in the example in FIG. 2, the storage unit 208 is provided outside the information processing apparatus 1, the storage unit 208 may be provided inside the information processing apparatus 1. The image data acquired by the image acquisition unit 201 is used for the learning of the neural network architecture.

A Ground Truth (GT) acquisition unit 202 acquires data of positions and/or sizes of objects appearing in the image acquired by the image acquisition unit 201, from the storage unit 208. The data of the positions and/or sizes of the objects acquired by the GT acquisition unit 202 is used in the learning of the neural network architecture.

More specifically, the information processing apparatus 1 includes the image acquisition unit 201 and the GT acquisition unit 202 as function units for acquiring the image data and the data of the positions and/or sizes of the objects in the image, as learning data to be used in the learning of the neural network architecture.

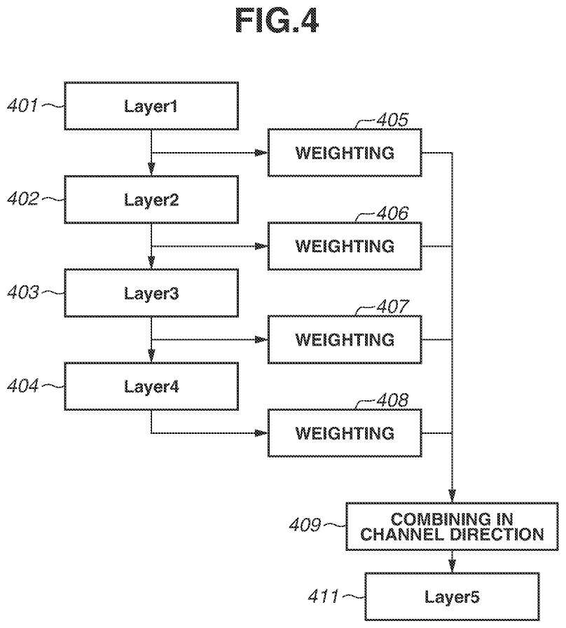

A candidate generation unit 203 generates edges (candidates) of the neural network. FIG. 4 illustrates an example of a neural network architecture generated by the candidate generation unit 203. As illustrated in FIG. 4, the network includes Layer 1 (401), Layer 2 (402), Layer 3 (403), Layer 4 (404), and Layer 5 (411). The outputs of the Layer 1 (401) to Layer 4 (404) are applied through weighting processes (405) to (408), respectively, combined in a channel direction through a combining process 409, and input to Layer 5 (411). Referring to the example in FIG. 4, the outputs of Layer 1 to Layer 4 are edges (candidates). The information processing apparatus 1 according to the present exemplary embodiment searches for the most suitable combination of edges from these edges (candidates).

The weighting processes 405, 406, 407, and 408 subject the outputs of Layer 1 to Layer 4, respectively, to weighting with weight coefficients. The weight coefficient is a value representing the importance of a Layer. A layer having a higher importance is applied with a larger weight coefficient. The weight coefficient is a parameter used for determining the neural network architecture, and the neural network architecture is determined by the magnitude of the value of a weight coefficient.

The weight coefficient is obtained through the learning of the neural network architecture (described below). More specifically, the weight coefficient indicating the importance of each edge (each candidate) is generated through the learning of the neural network architecture.

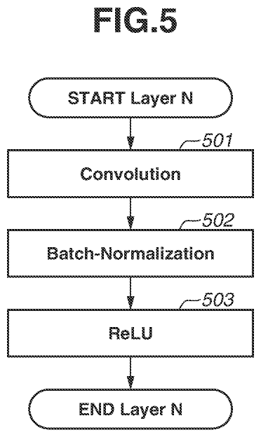

As illustrated in FIG. 5, each Layer in FIG. 4 includes convolution 501, a batch normalization 502, and a rectified linear unit 503 (hereinafter the rectified linear unit is referred to as ReLU). The example configuration in FIG. 5 is to be considered as illustrative. Instead of the ReLU, a Leaky ReLU or the Sigmoid function may be used, or MaxPooling and/or AveragePooling may be combined. The present exemplary embodiment does not limit the configuration of each Layer.

A selection number specification unit 204 specifies the number of candidates (edges) to be selected from all the edges (candidates) in the neural network. According to the present exemplary embodiment, the number of candidates to be selected specified by the selection number specification unit 204 is referred to as “specified candidate number”. The specified candidate number specified by the selection number specification unit 204 is predetermined based on speed requirements demanded for the neural network and memory requirements usable by the neural network. Generally, a neural network operates at higher speeds while saving the larger memory capacity with the smaller number of candidates. Thus, in the present exemplary embodiment, a specified number of candidates are selected from among all the edges (candidates) to reduce the number of candidates, thus implementing high operating speeds while saving the memory capacity.

Referring to the above-described example in FIG. 4, the specified candidate number is equivalent to the number of layers out of Layer 1 to Layer 4 of which the outputs are input to Layer 5. For example, when the candidate selection number is set to 3, the outputs of three Layers out of Layer 1 to Layer 4 are input to Layer 5.

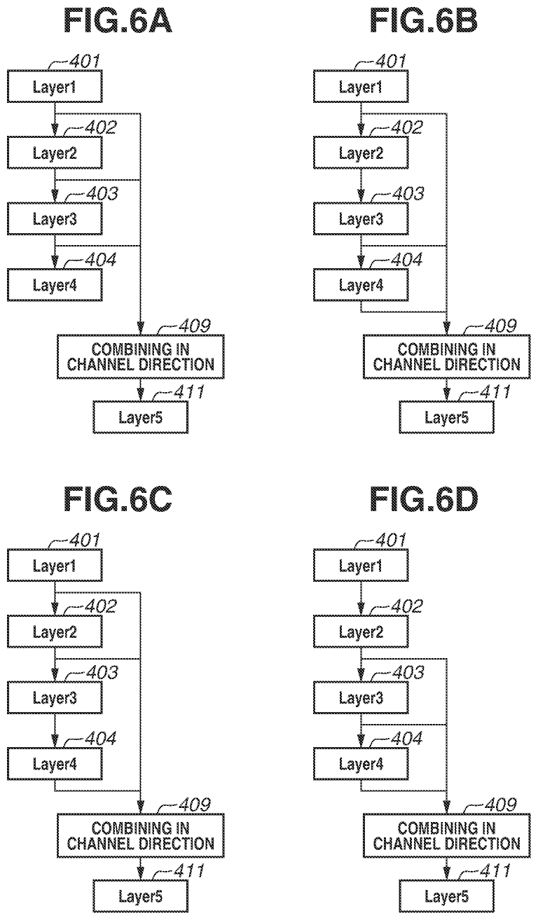

More specifically, when the candidate selection number is set to 3 for four layers of Layer 1 to Layer 4, any one of the four different networks illustrated in FIGS. 6A to 6D is acquired through the learning of the neural network architecture. In FIGS. 6A, 6B, 6C, and 6D, the weighting processes 405, 406, 407, and 408 is omitted, respectively. In FIG. 6A, for example, the outputs of Layer 1, Layer 2, and Layer 3 out of Layer 1 to Layer 4 are combined by the combining process 409 and then input to Layer 5. Similarly, in FIG. 6B, the outputs of Layer 1, Layer 3, and Layer 4 are combined and then input to Layer 5. In FIG. 6C, the outputs of Layer 1, Layer 2, and Layer 4 are combined and then input to Layer 5. In FIG. 6D, the outputs of Layer 2, Layer 3, and Layer 4 are combined and then input to Layer 5. Which of the networks in FIGS. 6A to 6D is to be acquired is determined based on the magnitude of the weight coefficients of the weighting process 405 to 408. The outputs of three layers having the first to the third largest weight coefficients out of Layer 1 to Layer 4, are combined and then input to Layer 5.

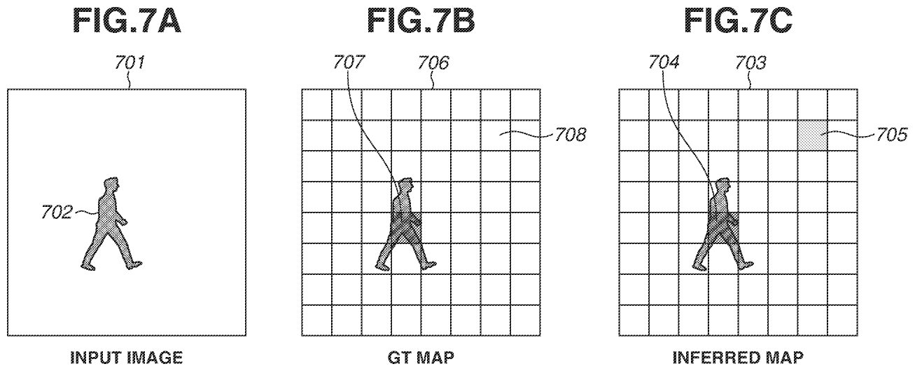

An inference unit 205 inputs the image acquired by the image acquisition unit 201 to the neural network illustrated in FIG. 4 as learning data, and then obtains the output of an inference result by the neural network. For example, with an image 701 illustrated in FIG. 7A input as learning data, the output of the inference result illustrated in FIG. 7C is acquired as an inference map 703 from the inference unit 205. More specifically, in a case where a person in the image 701 in FIG. 7A is a detection target 702, the output of the inference result made by the inference unit 205 is the inference map 703 illustrated in FIG. 7C. Referring to the inference map 703 illustrated in FIG. 7C, the value of the center of gravity position 704 corresponding to the detection target 702 in FIG. 7A is one, and the values of other portions are zero. To make it easier to understand the positional relation with the detection target 702 in FIG. 7A, the detection target (person) is also illustrated in the inference map 703 in FIG. 7C.

A loss calculation unit 206 calculates the loss (loss function) based on the output of the inference result made by the neural network acquired by the inference unit 205 and GroundTruth (GT) acquired by the GT acquisition unit 202. In a case where the image 701 illustrated in FIG. 7A is acquired by the image acquisition unit 201, GroundTruth is obtained as a GT map 706 illustrated in FIG. 7B. More specifically, in the GT map 706 in FIG. 7B, the value corresponding to the center of gravity (center of gravity of the person) of the detection target 702 in the image 701 in FIG. 7A is one, and the values of other portions are zero. To make it easier to understand the positional relation with the detection target 702 in FIG. 7A, the detection target (person) is also illustrated in the GT map 706 in FIG. 7B. According to the present exemplary embodiment, since the learning of the neural network architecture is performed based on the specified candidate number, the loss calculation unit 206 calculates the loss by using not only the output of the inference result and GT but also information about the specified candidate number. Details thereof will be described in detail below.

An updating unit 207 updates neural network parameters based on the loss calculated by the loss calculation unit 206, and stores the updated parameters in the storage unit 208.

The neural network parameters are classified into two different categories: parameters related to the neural network architecture, and the weights of elements, such as convolution, configuring the neural network. Referring to the example illustrated in FIG. 4, the parameters related to the neural network architecture are weight coefficients for the weighting processes 405 to 408.

A selection unit 209 selects each candidate (edge) based on the weight coefficient of the edge (candidate).

Referring back to the example in FIG. 4 according to the present exemplary embodiment, with the outputs of Layer 1 to Layer 4 sorted in descending order of the values of the weight coefficients, the selection unit 209 selects the specified candidate number of candidates in descending ranking. More specifically, the selection unit 209 selects the top n candidates, where n is the specified candidate number. The information processing apparatus 1 according to the present exemplary embodiment employs each of the candidates, corresponding in number to the specified candidate number, selected by the selection unit 209 to provide a neural network architecture.

A learning processing of the neural network architecture which is the information processing according to the present exemplary embodiment will be described in detail below with reference to the flowchart in FIG. 3. The information processing apparatus 1 does not necessarily need to perform all of the processes in the subsequent flowcharts.

In step S301, the candidate generation unit 203 generates a neural network architecture. FIG. 4 illustrates an example of an architecture generated by the candidate generation unit 203. As described above, the architecture illustrated in FIG. 4 subjects the outputs of the Layer 1, Layer 2, Layer 3, and Layer 4 to the weighting processes 405 to 408. The magnitudes of the weight coefficients at this time determine the network architecture. The output after weighting the i-th Layer is represented by Formula (1), where oᵢ denotes the output of the i-th Layer (i=1 to 4) and αᵢ denotes the weight coefficient for the i-th Layer.

oᵢ′(x)=αᵢ′oᵢ(x) Formula (1)

Referring to Formula (1), αᵢ′ is a coefficient represented by the Softmax function based on the weight coefficients for the candidates Layer 1 to Layer 4, as represented by the following Formula (2). The Softmax function is used in this way to set the value range of each weight coefficient to [0, 1].

$${𝒶}_{i}^{′} = \frac{exp ( {α}_{i} )}{{\sum }_{j} exp ( {α}_{j} )} \qquad Formula ( 2 )$$

In step S302, the selection number specification unit 204 sets the number of candidates to be selected from the candidates (edges) of the neural network (this number is referred to as the specified candidate number). Referring to FIG. 4 according to the present exemplary embodiment, the candidates are outputs of Layer 1, Layer 2, Layer 3, and Layer 4, and the selection number specification unit 204 specifies the number of layers to be input to Layer 5 out of the outputs of Layer 1 to Layer 4. For example, when the specified candidate number is set to 3, ₄C₃ different neural network structures are obtained as illustrated in FIGS. 6A to 6D as a result of the learning.

In step S303, the image acquisition unit 201 acquires an image stored in the storage unit 208. The present exemplary embodiment describes the above-described image 701 illustrated in FIG. 7A as an example of an acquired image. The image 701 includes the object (a person in this example) as the detection target 702.

In step S304, the GT acquisition unit 202 acquires GroundTruth (GT) stored in the storage unit 208. When the image 701 illustrated in FIG. 7A is acquired by the image acquisition unit 201, as in the present exemplary embodiment, GroundTruth is the GT map 706 illustrated in FIG. 7B. In the GT map 706 in FIG. 7B, the value of the center of gravity position 707 (center of gravity of the person) of the detection target 702 in the image 701 in FIG. 7A is one, and the values of other portions are zero.

In step S305, the inference unit 205 inputs the image acquired in step S303 to the neural network illustrated in FIG. 4 and then obtains an inference result. In a case where the image 701 in FIG. 7A is acquired in step S303, as described above, the inference result by the neural network provides the inference map 703 illustrated in FIG. 7C corresponding to the image 701 in FIG. 7A. As the learning progresses, the inference is performed so that the value of the center of gravity of the object to be detected is one, and the values of other portions are zero.

In step S306, the loss calculation unit 206 calculates the loss (loss function) based on the inference result obtained in step S305, GroundTruth (GT) obtained in step S304, and the specified candidate number set in step S302.

The loss calculation unit 206 calculates the following two different losses:
a loss for the inference result of the neural network; and
a loss related to the neural network architecture; and

The loss for the inference result of the neural network will be initially described below. The present exemplary embodiment describes an example of learning the neural network architecture in an object detection task. Thus, it is necessary for the neural network to properly detect the position of the object of the detection target 702 through the learning. For example, referring to the examples illustrated in FIGS. 7A to 7C, the learning is performed so that the inference map 703 in FIG. 7C, which is the output of the neural network, approaches the GT map 706 of GroundTruth illustrated in FIG. 7B.

The loss for the inference result of the neural network, Loss_{C}, is calculated by the sum of squared error for each pixel of the map, as represented by Formula (3), where C_{inf} denotes the output of the neural network output from Layer 5 (411) and C_{gt} denotes the GT map 706. In Formula (3), the total number of pixels in the GT map C_{gt} is denoted by N.

$${Loss}_{C} = \frac{1}{N} \sum {( {C}_{inf} - {C}_{gt} )}^{2} \qquad Formula ( 3 )$$

If the sum of squared error is calculated in this way, the value of loss increases when the value of the output C_{inf} of the neural network deviates from the GT map C_{gt}, and decreases when the output C_{inf} approaches the GT map C_{gt}. The learning progresses so that the loss decreases, so that the inference map, which is the output of the neural network, approaches the GT map of GroundTruth as the learning progresses.

For example, in the GT map 706 in FIG. 7B, the position 707 has a large value. In the inference map 703 in FIG. 7C, the value of the inference result at the position 704 is close to the large value of the position 707 in the GT map 706. As illustrated in FIGS. 7C and 7B, in a case where the position 704 in the inference map 703 and the position 707 in the GT map 706 are the same position, Formula (3) gives a small loss value as a result of the calculation.

In contrast to this, in the inference map 703 in FIG. 7C, the value of the inference result indicates a high value, for example, at a position 705. Here, in the GT map 706 in FIG. 7B, the inference result is assumed to be a low value at the corresponding position 708. In this case, since there is a large difference in value between the position 705 in the inference map 703 and the same position 705 in the GT map 706, Formula (3) gives a large loss value as a result of the calculation.

In the present exemplary embodiment, an example of obtaining the sum of squared error has been described, the present disclosure is not limited to the sum of squared error. For example, the loss function, such as cross-Entropy, may be obtained.

The loss calculation related to the neural network architecture will be described below. The present exemplary embodiment searches for a neural network architecture most suitable for the object detection task. In the present exemplary embodiment, the neural network architecture is determined based on which output to be selected according to the specified candidate number out of the outputs of Layer 1 to Layer 4 in FIG. 4. For example, in a case where the specified candidate number is three, three outputs out of the outputs of Layer 1 to Layer 4 are selected, and any of the above-described four different networks illustrated in FIGS. 6A to 6D is obtained.

Examples of possible methods for selecting the outputs corresponding to the specified candidate number from among the outputs of Layer 1 to Layer 4 include a method for preferentially selecting the output of a layer having a large weight coefficient in the weighting processes 405 to 408.

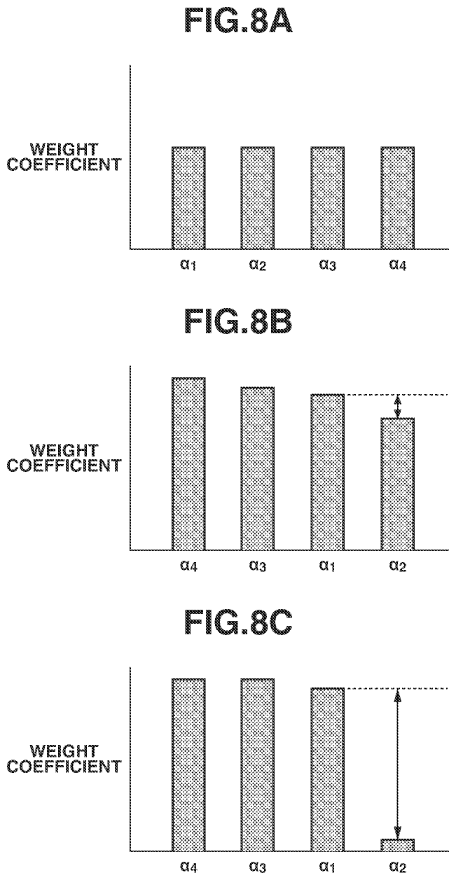

FIGS. 8A to 8C illustrate examples of the weight coefficients α₁ to α₄ for the weighting processes 405 to 408 corresponding to the outputs of Layer 1 to Layer 4, respectively. The weight coefficient for the weighting process 405 corresponding to Layer 1 is denoted by α₁. The weight coefficient for the weighting process 406 corresponding to Layer 2 is denoted by α₂. The weight coefficient for the weighting process 407 corresponding to Layer 3 is denoted by α₃. The weight coefficient for the weighting process 408 corresponding to Layer 4 is denoted by α₄.

In the initial state before the learning, the weight coefficients α₁ to α₄ for Layer 1 to Layer 4 are all the same value, respectively, as illustrated in FIG. 8A. As the learning progresses, the weight coefficient of a layer contributing to the object detection accuracy increases, and the weight coefficient of a layer not contributing thereto decreases. FIG. 8B illustrates examples of the weight coefficients α₁ to α₄ having changed as the learning progresses. In a case where the weight coefficients α₁ to α₄ change as illustrated in FIG. 8B, if the outputs of layers are to be selected, for example, based on the three largest weight coefficients α₄, α₃, and α₁, the outputs of Layer 4, Layer 3, and Layer 1 are selected.

In the example in FIG. 8B, the weight coefficient α₂ of Layer 2, which is not selected, is only slightly different from the weight coefficients α₄, α₃, and α₁ of selected Layer 4, Layer 3, and Layer 1, respectively. In this case, if the output of Layer 2 is excluded and only the outputs of Layer 4, Layer 3, and Layer 1 are selected, the neural network architecture may largely change. More specifically, if the weight coefficient of the weight coefficient of the layer that is not selected is only slightly different from the weight coefficients of the selected layers, any one of these selected layers and the unselected layer may be possibly be exchanged during the learning progresses. If such an exchange occurs or does not occur, the neural network architecture generated through the learning may possibly largely change. As a result of a large change in the neural network architecture, the inference accuracy of the object detection by the neural network also largely changes, resulting in a decrease in the inference accuracy, which is not desirable.

Thus, in a case where the outputs of a plurality of layers are selected according to the specified candidate number, it is desirable that the weight coefficients of the outputs of a plurality of layers corresponding to the candidates selected according to the specified candidate number increases to be a sufficiently large value as the learning progresses. On the contrary, it is desirable that the weight coefficient of the output of the layer corresponding to the unselected candidate, other than the specified candidate number, decreases to be a sufficiently small value. In other words, it is desirable that the weight coefficients of the outputs of a plurality of selected layers become largely different from the weight coefficient of the output of the unselected layer as the learning progresses. More specifically, as illustrated in FIG. 8C, it is desirable that the weight coefficients α₄, α₃, and α₁ of selected Layer 4, Layer 3, and Layer 1, respectively, sufficiently increase and the weight coefficient α₂ of unselected Layer 2 become sufficiently smaller than the weight coefficients α₄, α₃, and α₁ as the learning progresses.

Thus, in the calculation of the loss related to the neural network architecture, the information processing apparatus 1 according to the present exemplary embodiment calculates the loss so that the weight coefficients of the layers selected according to the specified candidate number increase and the weight coefficient of the unselected layer decreases.

More specifically, the loss calculation unit 206 initially sorts the weight coefficients αᵢ of different layers in descending order. The loss calculation unit 206 calculates Loss_{A} related to the neural network architecture by using Formula (4), where K denotes the specified candidate number.

Loss_{A}=exp(−(α_{K}−α_{K+1})²) Formula (4)

Formula (4) represents the loss function, where K denotes the specified candidate number. With the weight coefficients αᵢ sorted in descending order, assume the difference between the K-th largest weight coefficient α_{K} and the (K+1)-th largest weight coefficient α_{K+1}. The loss function is designed to decrease as the difference increases and to increase as the difference decreases. More specifically, the loss calculation unit 206 calculates the loss so that the value of loss increases with the decreasing difference between the weight coefficient of each of the candidates having the K largest weight coefficients and the weight coefficients of other candidates, where K is determined as the specified candidate number. In other words, the loss calculation unit 206 calculates the loss so that the value of the loss increases when the difference between the weight coefficient of each of the candidates corresponding in number to the specified candidate number and the weight coefficients of other candidates is smaller than, for example, a predetermined threshold value. More specifically, with the candidates sorted in descending order of the weight, the loss calculation unit 206 calculates the loss so that the value of the loss increases when the difference between the K-th and the (K+1)-th largest weights for candidates is smaller than a threshold value. On the other hand, since the learning progresses so that the loss function decreases, the difference between the K-th largest weight coefficient α_{K} and the (K+1)-th largest weight coefficient α_{K+1} increases as the learning progresses.

If the selection unit 209 selects a candidate having a larger weight coefficient on a priority basis, there may arise a difference between the specified candidate number and the number of candidates that are likely to be selected by the selection unit 209 based on the large weight coefficients thereof. Referring to Formula (4), if there arise a difference between the specified candidate number and the number of candidates to be selected by the selection unit 209 in the subsequent stage in this way, the loss calculation unit 206 calculates the loss so that the value of the loss increases.

This means that the weight coefficients can be brought close to the state illustrated in FIG. 8C as the learning progresses.

As described above, the loss calculation unit 206 calculates two different losses: Loss_{C} for the inference result of the neural network and Loss_{A} related to the neural network architecture. The loss calculation unit 206 then integrates Loss_{C} for the inference result of the neural network and Loss_{A} related to the neural network architecture to obtain the loss of the neural network by using Formula (5). In Formula (5), λ denotes weighting having a value range of [0, 1]. When weighting λ is increased, Loss_{C} for the inference result of the neural network converges earlier than Loss_{A}. On the other hand, when weighting λ is deceased, Loss_{A} related to the architecture converges earlier than Loss_{C}. Here, the weighting λ is determined on an experimental basis.

Loss=λLoss_{C}+(1−λ)Loss_{A} Formula (5)

The flowchart in FIG. 3 will be described again below. In step S307, the updating unit 207 updates the neural network parameters based on the loss calculated in step S306. Here, the neural network parameters include two different types: weights of elements, such as convolution, configuring the neural network, and weights related to the neural network architecture. The updating unit 207 updates the both parameters. The parameters are updated by using Momentum Stochastic Gradient Decent (SGD) based on back propagation. While the above-described examples relate to the output of the loss function for one image, the value of the loss is calculated using Formula (5) for a plurality of various images in the actual learning. Thus, the updating unit 207 updates the parameters for the neural network so that the value of the loss for each of the plurality of images is smaller than a predetermined threshold value.

In step S308, the updating unit 207 stores the updated parameters for the neural network in the storage unit 208.

In step S309, the updating unit 207 determines whether to end the learning. In the determination as to whether the learning is to be ended, the updating unit 207 may determine to end the learning in a case where the loss value acquired by Formula (5) is smaller than the predetermined threshold value and the learning converges or where the learning is completed a predetermined number of times. If the updating unit 207 determines to end the learning (YES in step S309), the processing proceeds to step S310. If the updating unit 207 determines not to end the learning (NO in step S309), the processing returns to step S303.

In step S310, the selection unit 209 uses the outputs with the first to the K-th largest weight coefficients out of the outputs of Layer 1 to Layer 4 to provide a neural network architecture. In the configuration in FIG. 4 where the specified candidate number K is three, if the result of sorting the weight coefficients in descending order is Layer 4, Layer 1, Layer 3, and Layer 2, the selection unit 209 selects the outputs of layers having the first to the third largest weight coefficients. More specifically, in such a case, the selection unit 209 selects the outputs of Layer 4, Layer 1, and Layer 3.

As described above, the information processing apparatus 1 according to the first exemplary embodiment selects candidates based on the specified candidate number and updates the neural network parameters while calculating the loss function represented by Formula (4). This results in a sufficiently large difference between the weight coefficient of each of the candidates selected according to the candidate selection number and the weight coefficient of the candidate that is not selected. More specifically, the present exemplary embodiment implements a high-speed, memory-saving neural network, and enables learning a neural network architecture that is capable of implementing high-accuracy object detection even if the outputs of the candidates that are not selected are excluded at the end of the learning.

A second exemplary embodiment will be described below. In the present exemplary embodiment, a technique for learning a neural network architecture in an object tracking task for detecting a specific tracking target in an image will be described. The present exemplary embodiment will be described below using an example of learning a tracking task based on the technique in Bertinetto, et al., “Fully-Convolutional Siamese Networks for Object Tracking”. The functional configuration of the information processing apparatus 1 according to the second exemplary embodiment is similar to that illustrated in FIG. 2, and redundant illustrations and descriptions thereof will be omitted.

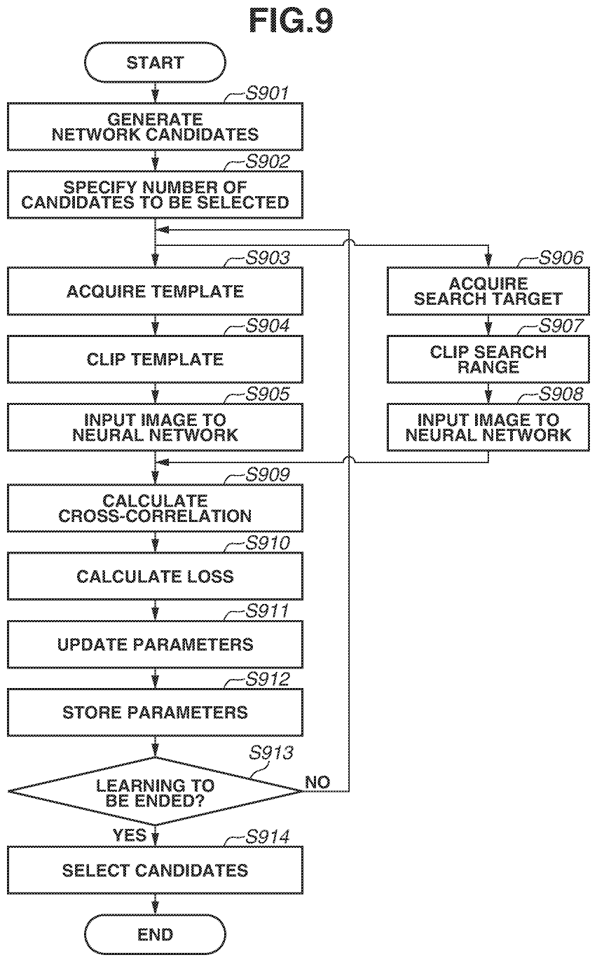

FIG. 9 is a flowchart illustrating an information processing, or a learning processing for the neural network architecture in the information processing apparatus 1 according to the second exemplary embodiment.

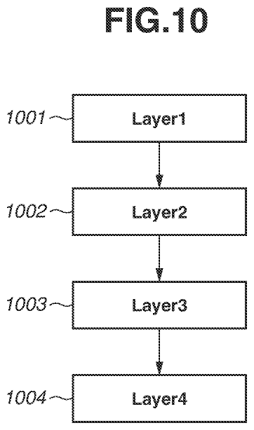

In step S901, the candidate generation unit 203 according to the second exemplary embodiment generates a neural network architecture as illustrated in FIG. 10. An example of a network illustrated in FIG. 10 includes Layer 1 (1001), Layer 2 (1002), Layer 3 (1003), and Layer 4 (1004).

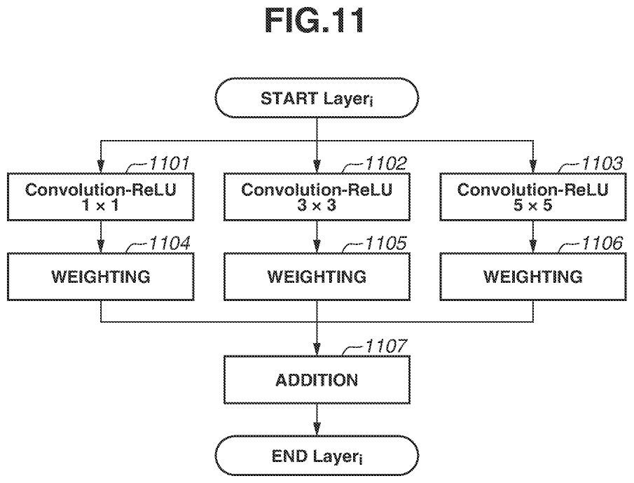

Each of these layers includes convolutions having different kernel sizes, as illustrated in FIG. 11. For example, in a convolution-ReLU 1101, non-linear transform, such as ReLU, is performed after the convolution processing with a kernel size of 1×1.

Similarly, in a convolution-ReLU 1102, non-linear transform is performed after the convolution processing with a kernel size of 3×3. In a convolution-ReLU 1103, non-linear transform is performed after the convolution processing with a kernel size of 5×5. The outputs of the convolution-ReLUs 1101 to 1103 are edges (candidates). In the present exemplary embodiment, a combination of the most suitable edges (candidates) is obtained through the learning of the neural network architecture.

A weighting process 1104 subjects the output of the convolution-ReLU 1101 to weighting process. Similarly, a weighting process 1105 subjects the output of the convolution-ReLU 1102 to weighting process, and a weighting process 1106 subjects the output of the convolution-ReLU 1103 to weighting process. The method for weighting a candidate is similar to that described in conjunction with the above-described Formula (1).

An addition 1107 adds the outputs of the weighting processes 1104 to 1106. The output of this addition operation is input to the following Layer.

In the configuration in FIG. 11, by obtaining the weight coefficients of the weighting processes 1104, 1105, and 1106 through the learning, at least one candidate contributing to the accuracy of the tracking task can be selected from the outputs of the convolution-ReLUs 1101, 1102, and 1103, respectively, as candidates. Types of candidate convolutions do not necessarily need to have the above-described different kernel sizes. For example, the number of convolution groups may be changed for use as candidates. Candidates are not limited to the convolutions but may be types of activated functions (such as ReLU, Leaky ReLU, and ELU) or types of Pooling (such as MaxPooling and AveragePooling).

The flowchart in FIG. 9 will be described again below.

In step S902, the selection number specification unit 204 sets the candidate selection number that is the number of candidates to be selected. According to the present exemplary embodiment, the selection number specification unit 204 specifies the number of candidates (candidate selection number) to be selected from three different candidates (outputs of the convolution-ReLUs 1101, 1102, and 1103) illustrated in FIG. 11 which are present in each of Layer 1 to Layer 4 illustrated in FIG. 10.

For example, with the candidate selection number set to two, two different candidates are selected in response to completion of the learning. Examples of the two different candidates include the outputs of the convolution-ReLUs 1101 and 1102, and the outputs of the convolution-ReLUs 1101 and 1103.

After completion of step S902, the operations in steps S903 to S905 and the operations in steps S906 to S908 are performed by the information processing apparatus 1.

In step S903, the image acquisition unit 201 acquires an image including the tracking target, as a template image. At this timing, the GT acquisition unit 202 acquires GroundTruth (GT), such as the position and size of the tracking target in the template image.

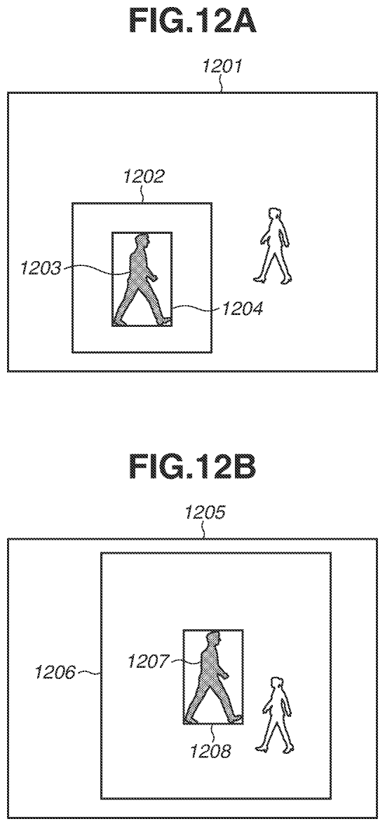

FIG. 12A illustrates an example of a template image 1201. The template image 1201, which includes a tracking target 1203, is acquired by the image acquisition unit 201. A bounding box (BB) 1204 indicating the position and size of the tracking target 1203 is set for the template image 1201.

In step S904, the image acquisition unit 201 clips and resizes an image of the periphery of the tracking target 1203 in the template image based on the position and size of the tracking target 1203 acquired by the GT acquisition unit 202. Examples of methods for clipping an image of the periphery of the tracking target 1203 include a method for clipping an image with an integer multiple of the size of a tracking target with the position of the tracking target 1203 as the center. A region 1202 illustrated in FIG. 12A is an example of a region with an image of the periphery of the tracking target 1203 clipped.

In step S905, the inference unit 205 inputs the image clipped from the template image 1201 in step S904 to the neural network and then obtains the feature of the tracking target 1203. After completion of step S905, the processing proceeds to step S909.

In step S906, the image acquisition unit 201 acquires a search target image to be subjected to tracking target search. For example, the image acquisition unit 201 acquires an image at a different time in the same sequence as the template image 1201 acquired in step S903, as a search target image to be subjected to tracking target search. FIG. 12B illustrates an example of a search target image 1205. The search target image 1205 illustrated in FIG. 12B includes a tracking target 1207. A BB 1208 indicating the position and size of the tracking target 1207 is set to the search target image 1205.

In step S907, the image acquisition unit 201 clips, as a search range, and resizes an image of the periphery of the tracking target 1207 in the search target image 1205 based on the position and size of the tracking target 1207 acquired by the GT acquisition unit 202. Examples of methods for clipping an image of the periphery of a tracking target as a search range include a method for clipping an image with an integer multiple of the size of the tracking target with the position of the tracking target 1207 as center. The search target image 1205 in FIG. 12B includes examples of the tracking target 1207, the BB 1208 indicating the position and size of the tracking target 1207, and a search range 1206 with an image of the periphery of the tracking target 1207 clipped.

In step S908, the inference unit 205 inputs the image of the search range 1206 clipped from the search target image 1205 in step S907 to the neural network and obtains the feature of the tracking target 1207. After completion of step S908, the processing proceeds to step S909.

In step S909, the inference unit 205 calculates the cross-correlation between the feature of the tracking target 1207 obtained from the template image 1201 in step S905 and the feature of the tracking target 1207 obtained from the search target image 1205 in step S906, and infers the position of the tracking target 1207 in the search target image 1205. In this case, the output of the cross-correlation calculation is an inference map described above in conjunction with FIG. 7C. The tracking target 1207 can be suitably tracked if the value of the position of the tracking target 1207 (a person in this example) is one, and the values of other positions are zero.

In step S910, the loss calculation unit 206 calculates the loss of the neural network. As in the first exemplary embodiment described above, the loss calculation unit 206 calculates two different losses: “the loss for the inference result of the neural network” and “the loss related to the neural network architecture”. Since the second exemplary embodiment learns an object tracking task, the processing for calculating the two different losses is slightly different from the processing according to the above-described first exemplary embodiment.

The loss for the inference result of the neural network according to the second exemplary embodiment will now be described below. The second exemplary embodiment exemplifies the learning of an object tracking task. Thus, the neural network needs to suitably detect the position of the tracking target object through the learning.

In step S910, the loss calculation unit 206 performs the loss calculation for such learning where the inference map in FIG. 7C, which is an example of an output of the neural network, approaches the GT map in FIG. 7B. The loss for the inference result of the neural network, Loss_{C}, is calculated by the sum of squared error for each pixel of the map, as represented by Formula (3), where C_{inf} denotes the output of the neural network output from Layer 4 (1004) in FIG. 10, and C_{gt} denotes the GT map.

The loss related to the neural network architecture will be describes below. The second exemplary embodiment describes an example of searching for a neural network architecture most suitable for an object tracking task. In this case, the network architecture is determined based on which of a plurality of convolution types (the convolution-ReLUs 1101, 1102, and 1103 illustrated in FIG. 11) are to be selected for each layer.

Examples of possible methods for selecting candidates of the convolution include a method for selecting the outputs of convolutions having large weight coefficients in the weighting processes 1104 to 1106 illustrated in FIG. 11, on a priority basis. In the second exemplary embodiment, it is also desirable that there is a sufficient difference between the weight coefficient of each of the selected candidates and the weight coefficients of the unselected candidates after completion of the learning of the network architecture, as in the above-described first exemplary embodiment. Thus, in the calculation of the loss related to the neural network architecture, the loss calculation unit 206 performs the loss calculation to increase the weight coefficient of each of selected convolutions and decrease the weight coefficient of unselected convolution.

More specifically, the loss calculation unit 206 initially sorts the weight coefficients αd of the respective layers in descending order. The loss calculation unit 206 then calculates Loss_{A} related to the neural network architecture based on Formula (6), where K denotes the candidate selection number.

$${Loss}_{A} = \frac{1}{K} {\sum }_{i \leq K} {( A - {α}_{i} )}^{2} + \frac{1}{N - K} {\sum }_{i > K} {α}_{i}^{2} \qquad Formula ( 6 )$$

Formula (6) means that, with the weight coefficients αᵢ sorted in descending order, the loss decreases as the values of the first to the K-th largest weight coefficients approach a sufficiently large value A, and the values of the (K+1)-th and the subsequent largest weight coefficients approach zero. The learning progresses so that the loss decreases. Thus, after completion of the learning of the network architecture, the values of the selected weight coefficients approach a sufficiently large value, and the values of the unselected weight coefficients approach zero. This enables the learning of the neural network architecture that implements high-accuracy object tracking even if the candidates of unselected convolutions are excluded.

Subsequently, by using Formula (5), the loss calculation unit 206 integrates Loss_{C} for the inference result of the neural network and Loss_{A} related to the neural network architecture to obtain the loss of the neural network.

The flowchart in FIG. 9 will be described again below.

In step S911 after completion of step S910, the updating unit 207 updates the neural network parameters based on the loss calculated in step S910 as in the operation in step S307 in the first exemplary embodiment.

In step S912, the updating unit 207 stores the updated neural network parameters in the storage unit 208.

In step S913, the updating unit 207 determines whether to end the learning. In the determination for the end of the learning, the updating unit 207 may determine to end the learning if the loss value acquired by Formula (5) is smaller than a predetermined threshold value or if the learning is completed a predetermined number of times. If the updating unit 207 determines to end the learning (YES in step S913), the processing proceeds to step S914. If the updating unit 207 determines not to end the learning (NO in step S913), the processing returns to steps S903 and S904.

In step S914, the selection unit 209 selects candidates based on the learned weight coefficients.

In the second exemplary embodiment, the neural network parameters are updated while the loss function represented by Formula (6) is calculated. This sufficiently increases the difference between the weight coefficient of each of the candidates selected according to the candidate selection number and the weight coefficients of the unselected candidates. In other words, the present exemplary embodiment implements a high-speed, memory-saving neural network, and enables learning a neural network architecture that can implement high-accuracy object tracking even if the outputs of the unselected candidates are excluded at the end of the learning.

A third exemplary embodiment will be described below. In the third exemplary embodiment, a description will be provided of a method for performing the pruning of the neural network in an example of an object tracking task as in the one according to the second exemplary embodiment. In the third exemplary embodiment, the loss calculation is performed based on the candidate selection number, which is a maximal value of the number of candidates to be selected. In the third exemplary embodiment, the loss calculation is performed so that the loss value increases if the number of candidates with the weight coefficients exceeding a predetermined threshold value exceeds a maximal value of the specified candidate number.

The functional configuration of the information processing apparatus 1 according to the third exemplary embodiment is similar to that illustrated in FIG. 2, and redundant illustrations and descriptions thereof will be omitted. The information processing in the information processing apparatus 1 according to the third exemplary embodiment is almost similar to the above-described flowchart in FIG. 9.

In the network architecture generated by the candidate generation unit 203 according to the third exemplary embodiment, each of the above-described Layer 1 (1001) to Layer 4 (1004) illustrated in FIG. 10 includes the convolution, the batch-normalization, and the ReLU illustrated in FIG. 5.

In the third exemplary embodiment, convolution channels are subjected to the pruning.

According to the present exemplary embodiment, a combination of the input and output of each channel of the convolution is an edge (candidate). The present exemplary embodiment obtains the most suitable combination of edges through the learning of the neural network architecture.

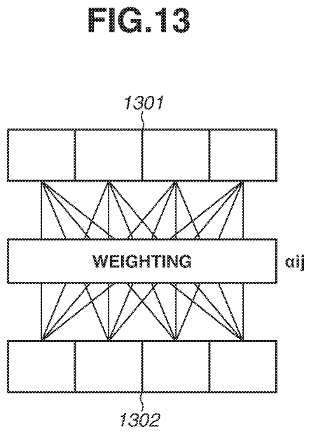

More specifically, the pruning of convolutions is performed based on the candidate selection number determined in step S902, in other words, the maximal value of the number of candidates to be selected. For example, as illustrated in FIG. 13, the output from the i-th input channel out of the input channels 1301 of the convolution to the j-th output channel 1302 is calculated by using the following Formulas (7) and (8).

$${o}_{j} = {\sum }_{i} {𝒶}_{ij}^{′} {w}_{ij} {x}_{i} \qquad Formula ( 7 )$$

$${α}_{ij}^{′} = \frac{exp ( {𝒶}_{ij} )}{{\sum }_{j} {\sum }_{i} exp ( {α}_{ij} )} \qquad Formula ( 8 )$$

Referring to Formulas (7) and (8), xᵢ denotes the input of the i-th channel, wᵢⱼ denotes the weight coefficient of the convolution from the i-th channel to the j-th channel, and au denotes the weight coefficient based on which the network architecture is determined.

Loss_{A} related to the network architecture can be calculated by using Formula (9), where K denotes the candidate selection number, which is the maximal value of the number of candidates to be selected.

$${Loss}_{A} = {λ}_{a} max ( 0 , \vert A \vert - K ) + {\sum }_{ij} \vert {α}_{ij}^{′} \vert A = \{ {α}_{ij}^{′} \vert {a}_{ij}^{′} > th \} \qquad Formula ( 9 )$$

In Formula (9), th denotes the threshold value for the weight coefficient, and is determined on an experimental basis. A set of weight coefficients exceeding the threshold value th is denoted by A. the weight coefficient for the first term of Formula (9) is denoted by λₐ, which is determined on an experimental basis. According to the first term of Formula (9), a loss occurs in a case where the number of weight coefficients of candidates exceeding the threshold value th exceeds K. A loss occurring when the number of weight coefficients exceeding the threshold value th exceeds K in this way produces an advantageous effect of limiting the number of selected weight coefficients to K or less. The second term of Formula (9) is an L1 regularization term for the weight coefficients, and is intended to obtain sparse weight coefficients.

According to the third exemplary embodiment, as described above, if the number of candidates as weight coefficients exceeding a predetermined threshold value exceeds a maximal value of the specified candidate number, the loss value increases. More specifically, in the third exemplary embodiment, the neural network parameters is updated while the loss function represented by Formula (9) is calculated. This enables the pruning of the convolution so that the number of candidates to be selected by the selection unit 209 falls within a range from 1 to K. Thus, reduction of the weight of the network is enabled while preventing the accuracy degradation in the third exemplary embodiment.

The disclosure of the present exemplary embodiment includes the following configurations and methods.

### (Configuration 1)

An information processing apparatus configured to learn an architecture for optimizing a structure of a neural network. The information processing apparatus includes a candidate generation unit configured to generate a plurality of candidates for an edge of the neural network, an inference unit configured to obtain an inference result by inputting learning data to the neural network with a weight coefficient set to each of the plurality of candidates for the edge, a loss calculation unit configured to calculate a loss of the neural network based on a specified candidate number which is the number of candidates to be selected from the plurality of candidates, and on the inference result, an updating unit configured to update the weight coefficient for each of the plurality of candidates based on the loss, and a selection unit configured to select candidates from the plurality of candidates based on the corresponding updated weight coefficient.

### (Configuration 2)

The information processing apparatus according to configuration 1, in a case where there is a difference between the specified candidate number and the number of candidates to be selected by the selection unit, the loss calculation unit calculates the loss so that a value of the loss increases.

### (Configuration 3)

The information processing apparatus according to configuration 1, in a case where a difference between a weight of individual candidates with the specified candidate number largest weights, out of the plurality of candidates, and weights of the other candidates is smaller than a predetermined threshold value, the loss calculation unit calculates the loss so that a value of the loss increases.

### (Configuration 4)

The information processing apparatus according to configuration 1 or 3, in a case where, with the plurality of candidates sorted in descending order of the weight, a difference between the K-th and the (K+1)-th largest weights for candidates is smaller than a predetermined threshold value, the loss calculation unit calculates the loss so that the value of the loss increases. K is the candidate specification number.

### (Configuration 5)

The information processing apparatus according to configuration 1, the loss calculation unit calculates the loss based on a maximal value of the specified candidate number.

### (Configuration 6)

The information processing apparatus according to configuration 5, in a case where the number of candidates having a weight exceeding a predetermined threshold value exceeds the maximal value of the specified candidate number, the loss calculation unit calculates the loss so that a value of the loss increases.

### (Configuration 7)

The information processing apparatus according to configuration 1, the loss calculation unit calculates a loss for the inference result of the neural network and a loss related to a neural network architecture. In the calculation of the loss related to the neural network architecture, the loss calculation unit calculates the loss based on the specified candidate number and the inference result.

### (Configuration 8)

The information processing apparatus according to configuration 7, the loss calculation unit acquires a loss into which the loss for the inference result of the neural network and the loss related to the neural network architecture are integrated, as the loss of the neural network.

### (Configuration 9)

The information processing apparatus according to configuration 1, a weight of each candidate is a weight coefficient indicating an importance.

### (Configuration 10)

The information processing apparatus according to configuration 1, the neural network is a neural network for detecting a detection target or tracking a tracking target in an image.

### (Method 1)

An information processing method which is executed by an information processing apparatus configured to learn an architecture for optimizing a structure of a neural network. The information processing method includes generating a plurality of candidates for an edge of the neural network, obtaining an inference result by inputting learning data to the neural network with a weight coefficient set to each of the plurality of candidates for the edge, calculating a loss of the neural network based on a specified candidate number which is the number of candidates to be selected from the plurality of candidates, and on the inference result, updating the weight coefficient for each of the plurality of candidates based on the loss, and selecting candidates from the plurality of candidates based on the corresponding updated weight coefficient.

### (Program 1)

A non-transitory computer-readable storage medium storing a computer-executable program for causing a computer to perform the method according to Method 1.

Although the above-described exemplary embodiments have exemplified a human body as a detection target, the detection target is not limited to a human body but may be a vehicle, bicycle, motorcycle, or animal.

The present disclosure can also be implemented when a program for implementing at least one of the functions according to the above-described exemplary embodiments is supplied to a system or apparatus via a network or storage medium, and at least one processor in a computer of the system or apparatus reads and executes the program. Further, the present disclosure can also be implemented by a circuit (for example, an application specific integrated circuit (ASIC)) for implementing at least one function.

The above-described exemplary embodiments are to be considered as illustrative in embodying the present disclosure, and are not to be interpreted as restrictive on the technical scope of the present disclosure.

The present disclosure may be embodied in diverse forms without departing from the technical concepts or essential characteristics thereof.

The present disclosure makes it possible to learn a neural network architecture for implementing a sufficient inference accuracy while preventing the increase in the amount of processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-063501, filed Apr. 6, 2022, which is hereby incorporated by reference herein in its entirety.

What is claimed is:

1. An information processing apparatus configured to learn an architecture for optimizing a structure of a neural network, the information processing apparatus comprising:
a candidate generation unit configured to generate a plurality of candidates for an edge of the neural network;
an inference unit configured to obtain an inference result by inputting learning data to the neural network with a weight coefficient set to each of the plurality of candidates for the edge;
a loss calculation unit configured to calculate a loss of the neural network based on a specified candidate number which is the number of candidates to be selected from the plurality of candidates, and on the inference result;
an updating unit configured to update the weight coefficient for each of the plurality of candidates based on the loss; and
a selection unit configured to select candidates from the plurality of candidates based on the corresponding updated weight coefficient.

2. The information processing apparatus according to claim 1, wherein, in a case where there is a difference between the specified candidate number and the number of candidates to be selected by the selection unit, the loss calculation unit calculates the loss so that a value of the loss increases.

3. The information processing apparatus according to claim 1, wherein, in a case where a difference between a weight of individual candidates with the specified candidate number largest weights, out of the plurality of candidates, and weights of the other candidates is smaller than a predetermined threshold value, the loss calculation unit calculates the loss so that a value of the loss increases.

4. The information processing apparatus according to claim 1,
wherein, in a case where, with the plurality of candidates sorted in descending order of weights thereof, a difference between the K-th and the (K+1)-th largest weights for candidates is smaller than a predetermined threshold value, the loss calculation unit calculates the loss so that a value of the loss increases, and
wherein K is the specified candidate number.

5. The information processing apparatus according to claim 1, wherein the loss calculation unit calculates the loss based on a maximal value of the specified candidate number.

6. The information processing apparatus according to claim 5, wherein, in a case where the number of candidates having a weight exceeding a predetermined threshold value exceeds the maximal value of the specified candidate number, the loss calculation unit calculates the loss so that a value of the loss increases.

7. The information processing apparatus according to claim 1,
wherein the loss calculation unit calculates a loss for the inference result of the neural network and a loss related to a neural network architecture, and
wherein, in the calculation of the loss related to the neural network architecture, the loss calculation unit calculates the loss based on the specified candidate number and the inference result.

8. The information processing apparatus according to claim 7, wherein the loss calculation unit acquires a loss into which the loss for the inference result of the neural network and the loss related to the neural network architecture are integrated, as the loss of the neural network.

9. The information processing apparatus according to claim 1, wherein a weight of each candidate is a weight coefficient indicating an importance.

10. The information processing apparatus according to claim 1, wherein the neural network is a neural network for detecting a detection target or tracking a tracking target in an image.

11. An information processing method which is executed by an information processing apparatus configured to learn an architecture for optimizing a structure of a neural network, the information processing method comprising:
generating a plurality of candidates for an edge of the neural network;
obtaining an inference result by inputting learning data to the neural network with a weight coefficient set to each of the plurality of candidates for the edge;
calculating a loss of the neural network based on a specified candidate number which is the number of candidates to be selected from the plurality of candidates, and on the inference result;
updating the weight coefficient for each of the plurality of candidates based on the loss; and
selecting candidates from the plurality of candidates based on the corresponding updated weight coefficient.

12. A non-transitory computer-readable storage medium storing a computer-executable program for causing a computer to perform a method which is executed by an information processing apparatus configured to learn an architecture for optimizing a structure of a neural network, the information processing method comprising
generating a plurality of candidates for an edge of the neural network;
obtaining an inference result by inputting learning data to the neural network with a weight coefficient set to each of the plurality of candidates for the edge;
calculating a loss of the neural network based on a specified candidate number which is the number of candidates to be selected from the plurality of candidates, and on the inference result;
updating the weight coefficient for each of the plurality of candidates based on the loss; and
selecting candidates from the plurality of candidates based on the corresponding updated weight coefficient.
